(19) United States
(12) Patent Application Publication
(10) Pub. No.: US 2018/0232949 A1
(43) Pub. Date: Aug. 16, 2018

(54) MEDIAL AXIS TRANSFORMATION AS A SOLID MODELING REPRESENTATION METHOD FOR COMPUTER AIDED DESIGN SOFTWARE

(71) Applicant: ECOLE POLYTECHNIQUE FEDERALE DE LAUSANNE (EPFL), Lausanne (CH)

(72) Inventors: Mihai-Bogdan LAZAR, Crissier (CH); Ian Anthony STROUD, Lausanne (CH); Paul XIROUCHAKIS, St-Sulpice (CH); Guillaume GOUALARD, Lausanne (CH); Florian BARRAS, Nyon (CH)

(21) Appl. No.: 15/514,340

(22) PCT Filed: Sep. 24, 2015
(86) PCT No.: PCT/IB2015/057359

§ 371 Date: Mar. 24, 2017

(30) Foreign Application Priority Data
Sep. 26, 2014 (IB) PCT/IB2014/064857

(51) Int. Cl. G06T 17/10; G05B 19/4093

(52) U.S. Cl. CPC G06T 17/10; G05B 2219/35037; G05B 2219/34113; G05B 19/4093

(57) ABSTRACT

A method for achieving a representation of an object within a data structure for a Computer Aided Design system employing a Medial Axis Transformation (MAT), the representation of the object comprising a set of adjacent bounded surface elements called MAT faces, the MAT faces being bound by sets of MAT edges, which are portions of curves lying on a surface of the MAT faces on either side of the edge, and points where several MAT faces meet are called MAT vertices. The method comprises at least defining each of the MAT vertices as points in a space domain; assigning a radius function to each of the MAT vertices, based on only a single value; defining each of the MAT edges as a curve in space; defining limits of each of the MAT edges as two MAT vertexes which lie on the curve; assigning a radius function to each of the MAT edges; defining each of MAT faces as a surface in space; defining the limits of each of the MAT faces as a MAT loop, comprising at least three MAT edges, sharing each a MAT node, whereby a direction, clockwise or counter-clockwise, of the MAT loop defines on which side of the MAT loop the MAT face will be formed; defining the MAT links as the edges which are shared by at least two MAT faces; assigning a radius function to each of the MAT faces; and defining a MAT object as a connected set of MAT faces, edges and vertices.

### TECHNICAL FIELD

The present invention relates to the field of Computer-Aided Design and more particularly to the methods of representation of a solid object within such a framework.

### BACKGROUND

Prior art CAD systems approach the design from solely a geometry point of view.

A strong interest exists to allow attaching physical meaning to such designs. Previous attempts in merging or integrating the CAD systems with the Finite Element Methods of simulation have failed or provide unsatisfactory results. The inventors of the present invention believe that it is due to the way the geometry is represented by only its boundaries.

### SUMMARY OF THE INVENTION

The present invention introduces a new way to represent an object in CAD systems, allowing to address the problem of attaching physical meaning to designs and to represent objects that are changing their position, orientation and shape in time.

In a first aspect, the invention provides a method for achieving a representation of an object within a data structure for a Computer Aided Design (CAD) system employing a Medial Axis Transformation (MAT), the representation of the object comprising a set of adjacent bounded surface elements called medial axis transformation faces, the medial axis transformation faces being bound by sets of medial axis transformation edges, which are portions of curves lying on a surface of the medial axis transformation faces on either side of the edge, and points where several medial axis transformation faces meet are called medial axis transformation vertices. The method comprises at least defining each of the medial axis transformation vertices as points in a space domain; assigning a radius function to each of the medial axis transformation vertices, based on only a single value; defining each of the medial axis transformation edges as a curve in space; defining limits of each of the medial axis transformation edges as two medial axis transformation vertexes which lie on the curve; assigning a radius function to each of the medial axis transformation edges; defining each of medial axis transformation faces as a surface in space; defining the limits of each of the medial axis transformation faces as a medial axis transformation loop, comprising at least three medial axis transformation edges, sharing each a medial axis transformation node, whereby a direction, clockwise or counter-clockwise, of the medial axis transformation loop defines on which side of the medial axis transformation loop the medial axis transformation face will be formed; defining the medial axis transformation links as the edges which are shared by at least two medial axis transformation faces; assigning a radius function to each of the medial axis transformation faces; and defining a medial axis transformation object as a connected set of medial axis transformation faces, edges and vertices.

In a preferred embodiment, in the step of assigning the radius function to each of the medial axis transformation edges, the function is linear, whereby the radius varies linearly along the medial axis transformation edge.

In a further preferred embodiment, in the step of assigning the radius function to each of the medial axis transformation edges, the function is non-linear, whereby the radius does not vary linearly along the medial axis transformation edge.

In a further preferred embodiment, in the step of assigning the radius function to each of the medial axis transformation edges, the function is defined numerically, piece-wise linear or by other methods to define numerical functions.

In a further preferred embodiment, in the step of assigning the radius function to each of the medial axis transformation faces, the function is linear, whereby the medial axis transformation vertices and medial axis transformation edges are linear and coplanar.

In a further preferred embodiment, in the step of assigning the radius function to each of the medial axis transformation faces, the function is non-linear.

In a further preferred embodiment, in the step of assigning the radius function to each of the medial axis transformation edges, the function is defined numerically, piece-wise linear or other methods for defining numerical functions.

In a further preferred embodiment, the representation of the object is achieved together with a Boundary Representation (BREP), and the method further comprises for each medial axis transformation data structure element, assigning a link to boundary representation data structure elements defining the respective medial axis transformation element; and for each boundary representation data structure element assign a link to the medial axis transformation data structure elements defining the respective boundary representation element.

In a second aspect, the invention provides a Computer Aided Design CAD system configured to implement geometric engine functions that use a medial axis transformation based data structure as a solid representation method.

In a further preferred embodiment of the system, the geometric engine functions use the medial axis transformation based data structure solid representation method together with a boundary representation method.

In a third aspect, the invention provides a Computer Aided Design CAD system configured to implement part and assembly modeling functions that use a medial axis transformation based data structure as a solid representation method.

In a further preferred embodiment of the system, the part and assembly modeling functions use the medial axis transformation based data structure solid representation method together with a boundary representation method.

In a fourth aspect, the invention provides a user interface configured to enable a creation and manipulation of objects represented by a medial axis transformation-based data structure at least as a solid representation method.

In a further preferred embodiment of the method for achieving a representation of an object within a data structure for a Computer Aided Design (CAD) system, the representation of the object further comprises a 4th parameter corresponding to time and a medial axis transformation shell, thereby enabling a 4-dimensional solid representation method.

In a fifth aspect, the invention provides a Computer Aided Design CAD system configured to implement geometric engine functions that use a 4-dimensional solid representation method.

In a sixth aspect, the invention provides a Computer Aided Design CAD system configured to implement part and assembly modeling functions that use a 4-dimensional solid representation method.

In a seventh aspect, the invention provides a user interface configured to enable a creation and manipulation of objects represented in a 4-dimensional environment by a 4-dimensional solid representation method.

### BRIEF DESCRIPTION OF THE FIGURES

The invention will be better understood in view of the detailed description of preferred embodiments, and in reference to the figures, wherein

FIG. 1 shows a typical structure of a CAD system according to prior art;

FIG. 2 illustrates a single object boundary representation data structure;

FIG. 3 illustrates a structure of a typical modelling structure of a CAD kernel according to prior art;

FIG. 4 contains a comparison between BRep and MAT representation models;

FIG. 5 illustrates a new single object Medial Axis Transformation data structure;

FIG. 6 contains a schematic representation of a data structure of a sample 2D object in both BREP and MAT methods;

FIG. 7 shows a 3D L-shaped object represented by its boundaries—skin;

FIG. 8 shows a 3D L-shaped object represented by its Medial Axis Transformation—skeleton. The radius function, albeit continuous, is visually represented discreetly at MAT vertices by a sphere of equal radius; and

FIG. 9 shows a 3D L-shape object abstraction represented by the main elements of its medial axis transformation, i.e., only faces with non-zero radii.

### DETAILED DESCRIPTION OF PREFERRED EMBODIMENTS

### Definitions

### Computer Aided Design

Computer Aided Design (CAD) is the use of a computer system to assist with the creation, modification, analysis or optimization of a design. One particular interest of CAD systems—and in particular to ones for mechanical design—is the task of representing and manipulating an object's shape.

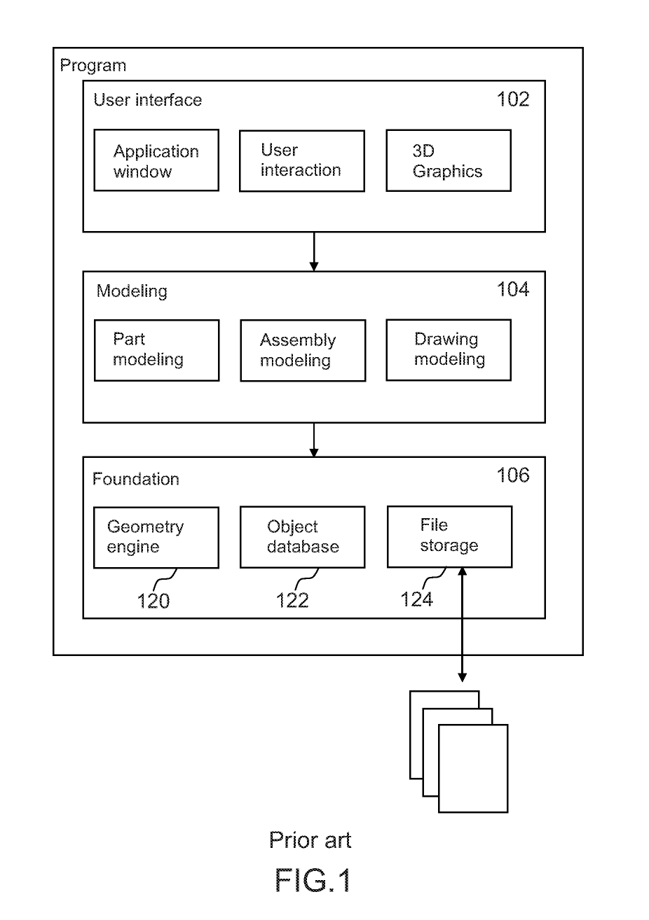

A typical architecture of a modern CAD system according to prior art is exemplified in FIG. 1. It can be divided into three components, i.e., a user interface 102, modeling functions 104, and a foundation 106. The foundation 106, also referred to as the kernel or the core of a CAD system comprises a set of geometrical (and sometimes topological—not represented in FIG. 1) functions 120 configured to interrogate and modify an object database 122, and file storage functions 124 configured to organize the object database 122 into a formatted file—not represented in FIG. 1.

An object may be represented geometrically, i.e., as a set of geometrical data, or parametrically, i.e., a geometric object plus an ordered set of features, e.g., functions used in the creation of the objects-104 in FIG. 1. The creation of an object—or a part—is done by basically three methods:
manipulation of 2D sections;
creation of edge features by modification of the sharp boundaries between faces, e.g., fillet, chamfer;
combining and manipulating solid primitives.

Differences exist in current CAD system in the way the objects are created and manipulated. However, all of them make use of a single method to represent the object in the database, the so-called Boundary Representation (BREP). The representation of the geometrical model is referred to as solid modeling, which is a consistent set of principles for mathematical and computer modeling of 3D solids. Unlike related topics as computer graphics or geometric modeling, the solid modeling emphasizes on physical fidelity, by guaranteeing a proof of integrity of the solid.

### Solid Modeling Representation Model

A solid modeling representation model is a method to capture geometrical and topological data of a virtual object in the form of a data structure. The minimum requirement for a solid modeling representation model is to provide a point classification function, i.e., to be able to tell whatever a point is inside or outside a solid object—in other words to provide a proof that the object is fully defined.

Several modeling representation models exist:
Boundary Representation (BRep) which is the most widely used and particularly suitable for CAD applications;
parameterized primitive instancing and constructive solid geometry (CGS) which proved to be unsuitable for defining complex objects;
cell decomposition is mostly used in Finite Element Analysis software, i.e. mesh;
spatial enumeration is a particular case of cell decomposition along well structured directions, producing an image-type of representation, in 3D space—voxel-based—which is used in certain Finite Element Analysis applications and X-Ray Computed Tomography;
sweeping is the creation and modification of solid objects by only the sweeping operation of 2D shapes and is used for niche applications of CAD;
implicit representation—function representation—is an analytical way of representing solid objects. It is rarely used in mathematics as the model becomes too complex and computationally expensive for complex parts;
parametric and future-based modeling is used to store the history of construction of a solid object in many CAD systems as a complement to the Boundary Representation. It can be regarded as a sole representation, although the current implementations still make use of the BREP data structure to store the current shape of the object.

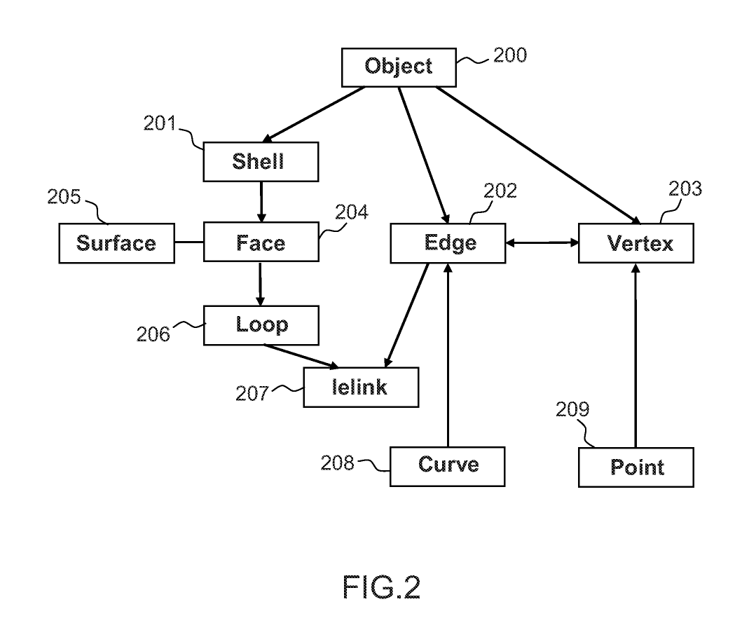

Boundary representation (BRep) is used in most of CAD systems and consists in representing and manipulating solid models in terms of the “skin” surrounding them. The skin—or shell—is composed of a set of adjacent bounded surface elements, called faces. Faces are bound by sets of edges, which are portions of curves lying on the surface of the faces on either side of the edge. The points where several faces meet are called vertices. In FIG. 2 a typical data-structure organization of a BRep solid is introduced: an object 200 comprises a list of shells 201, edges 202 and vertices 203: a shell 201 is defined by a closed group of faces 204, each defined as an infinite surface 205 bounded by one or more loops 206 of edges 202—the edges are linked together to form a loop 206, by lelink 207, a convention to define which side of the loop 206, the face 204 should be formed; edges 202 are also defined as infinite curves 208, bounded by two vertices, defined as geometrical points 209 in space. The same data-structure can be used to define 2-dimensional objects, by “skipping” the definition of the shell: single face, where the defining surface is in fact the 2-dimensional space in which the object lies.

The first introduction of the Boundary Representation is accredited to (Braid I., 1974) and (Braid, Hillyard, & Stroud, 1980) while the current state-of-art is more elaborated in (Stroud I., 2006).

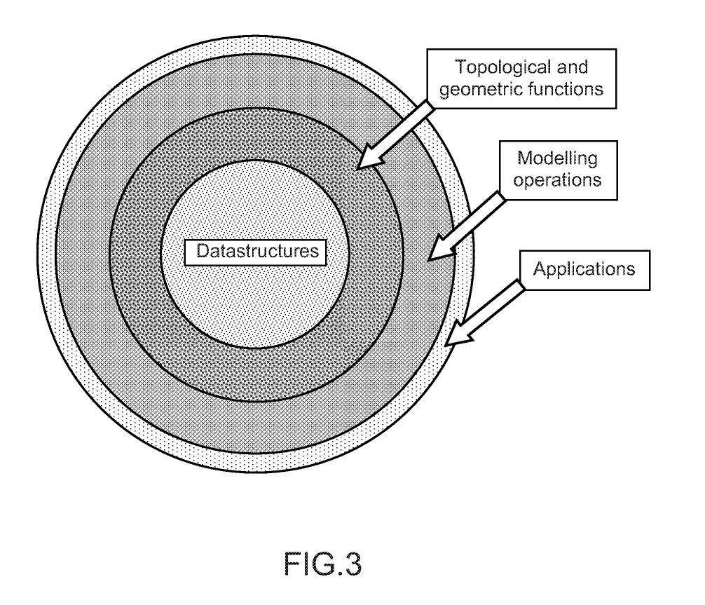

Around the data structure, the complete functionality of a CAD system is constructed in an onion-like structure as illustrated in FIG. 3. The topological and geometric functions illustrated by a first envelope are used to navigate and modify the data structure, illustrated as a kernel, as needed. The modeling operations, illustrated in a second envelope, usually accessible to the user through a graphical user interface—not illustrated in FIG. 3—do not access directly the data structure, but the topological and geometrical function. Applications are the last envelope. An application defines the purpose of the utilization—here, by the CAD system, but a kernel might not be limited to such an application, other Computer-Aided Engineering systems can be based upon.

### Medial Axis Transformation as a Solid Modeling Representation

The Medial Axis (MA) of a solid object is the locus of the center points of all maximal spheres inside an object. A maximal inscribed sphere is a sphere that is contained in the object but which is not a proper subset of, i.e., completely contained in, any other sphere inside the object. In other words, Medial Axis is the set of all points having more than one closest point on the object's boundary. It is sometimes referred to as the topological skeleton. To the Medial Axis, a radius function can be assigned with the value of the radius of the corresponding maximal sphere at each point of the Medial Axis. The Medial Axis together with the radius function is called the Medial Axis Transform (MAT). The Medial Axis of 3D solid is a structure containing basically faces and therefore, sometimes referred to as “medial surface”.

The Medial Axis was first introduced by (Blum, 1973) as a means to describe biological shapes and since then it is used mostly in the academic world in various algorithms and applications. Up to now it was exclusively regarded as a property of an object containing additional sought-after topological information.

The present invention, proposes a solid modeling representation model based on the Medial Axis Transformation principle to be used for application to Computer-Aided Design systems.

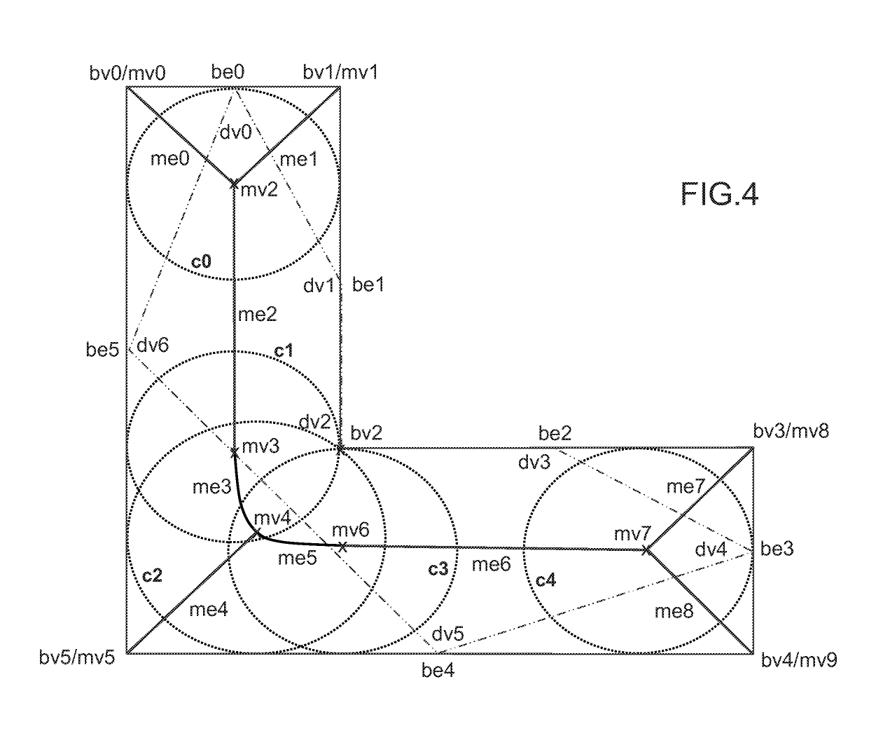

FIG. 4 illustrates the difference between the Boundary Representation model and the newly proposed MAT model for a 2-dimensional object. Each vertex and edge of the object is labeled by “v” and “e” respectively. The boundary elements are preceded by the letter “b” while the MAT elements by the letter “m”. The boundary elements contain only geometrical data, i.e., point coordinate or curve description as in FIG. 2, while the MAT elements contain an additional term, the radius function, i.e., single value for points, single parameter function for edges or 2-parameter function for faces (not illustrated, pertaining to 3D objects). It is noted that for the MAT vertices with zero radius coincide with the Boundary ones. Additionally, the modified-DUAL—a graph-theory representation of the connections between the BREP elements—is also introduced by showing the links in the FIG. 4, while its nodes are labeled by “d”. The modified-DUAL—modified, as it includes the convex corners—is used in the conversion process between the BREP representation and the MAT as it will be later exemplified.

It should be noted that each MAT element is defined, i.e., linked, by several BREP elements. For exemplification, MAT vertex 7 (mv7) is defined as the center of the circle tangent to BREP edge 2 (be2); BREP edge 3 (be3) and BREP edge 4 (be4). Consequently, each BREP element can be defined (or linked) by several MAT elements. For example, BREP edge 4 (be4) is defined as the edge tangent to the circles corresponding to MAT elements mv5, me4, me5, mv6, me6, mv7 and me8; furthermore, the zero-radius MAT nodes (mv5 and mv9) define the limits of the edge. It should be noted also that MAT edges me5 and me3 are not linear. For this particular case, they are parabolic curves. The radius function along these edges is also defined as a 2nd degree single parameter function.

A similar representation can be developed for 3-dimensional objects.

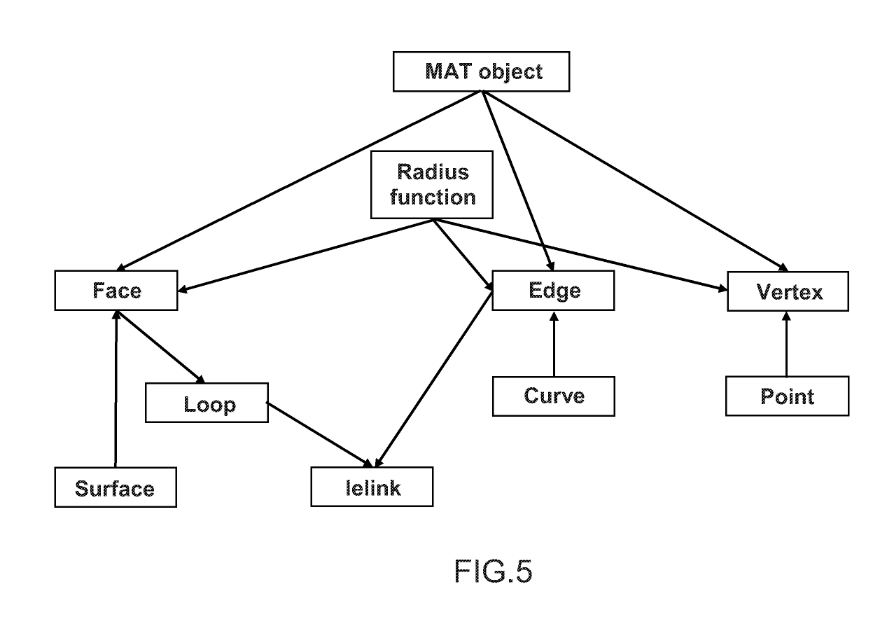

A data structure to capture the full extent of MAT information has been developed as introduced in FIG. 5. The resemblance with the BREP data-structure introduced in FIG. 2 can be noted, with the following important differences highlighted:
the MAT object is defined by only a set of faces (linked to form a graph), edges and vertices, i.e., the shells are not needed anymore—at least for 3D objects;
to each of the constituting elements of the MAT object (faces, edges and vertices) a radius function is assigned.

As it will be shown below, the MAT data-structure can be used alone to represent an object in a CAD environment or in relationship with a BREP data-structure to form a hybrid-representation.

Various methods have been proposed by the research community to calculate the medial axis of solid models, among which the so-called “divide and conquer” algorithm by (Stroud, Renner, & Xirouchakis, 2007). The named algorithm, calculates the MAT structure based on the triangulation of the modified-DUAL, as introduced in FIG. 4; each triangle obtained—referred to as Delaunay triangle—defining a MAT vertex. However, most of these algorithms are incomplete as they do not generate all the needed information to describe the solid object, nor capture their results in a formal way. They were intended solely to extract certain information about the MAT to assist in the development of particular applications.

By extending the above mentioned algorithm (Stroud, Renner, & Xirouchakis, 2007) or potentially employing equivalent ones, the conversion can be assured between the BREP and MAT representations.

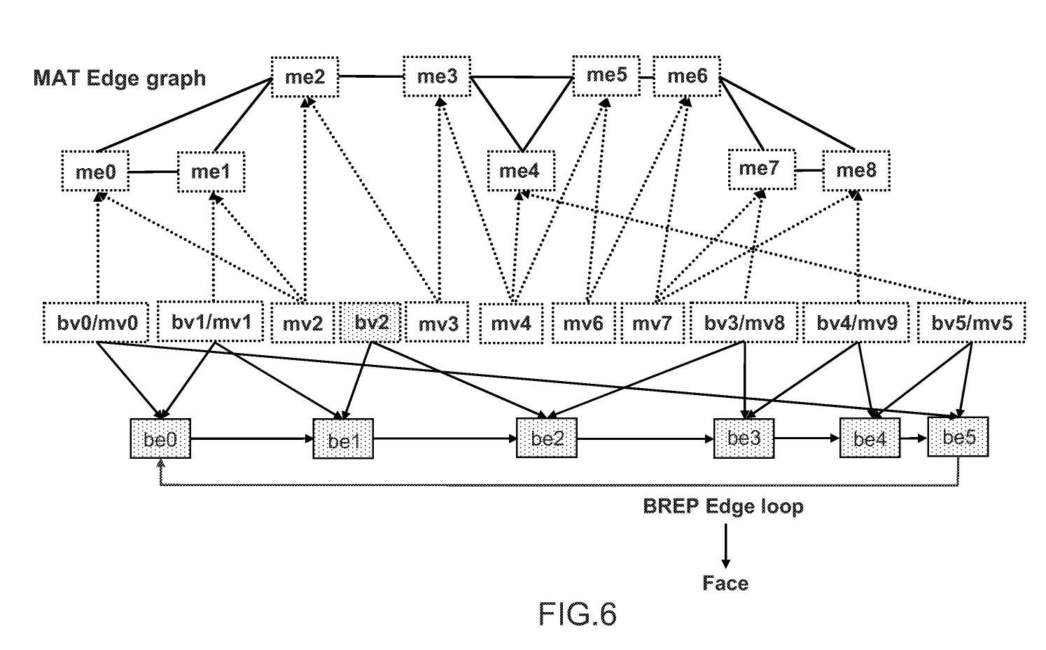

For comparison, FIG. 6 introduces the data structure representation of the sample 2D object in FIG. 4. The boundary vertices (bvX) define the limits of the otherwise infinite BREP edges (beX) which form a loop to close the 2D object, i.e., a face. The MAT vertices (mvX) define the limits of the MAT edges (meX) which form a graph to represent the 2D object. The graph can be explicitly defined or implicitly by checking the common MAT vertices of MAT edges. It is noted that the BREP vertices contain only the coordinate of the points—(x,y) in the current case and the BREP edges are defined by infinite curves (limited by the defining BREP vertices). On the contrary, the MAT vertices contain an additional parameter corresponding to the radius of the inscribed circle—(x,y,R) and the MAT edges also have a radius function, i.e., constant as for (me2) and (me6); linear for (me0), (me1), (me4), (me7) and (me8) and 2nd degree respectively for (me3) and (me5). The MAT edges (me0), (me1), (me4), (me7) and (me8), which are defined by vertices with zero radiuses, identical with BREP vertice, are called wind edges.

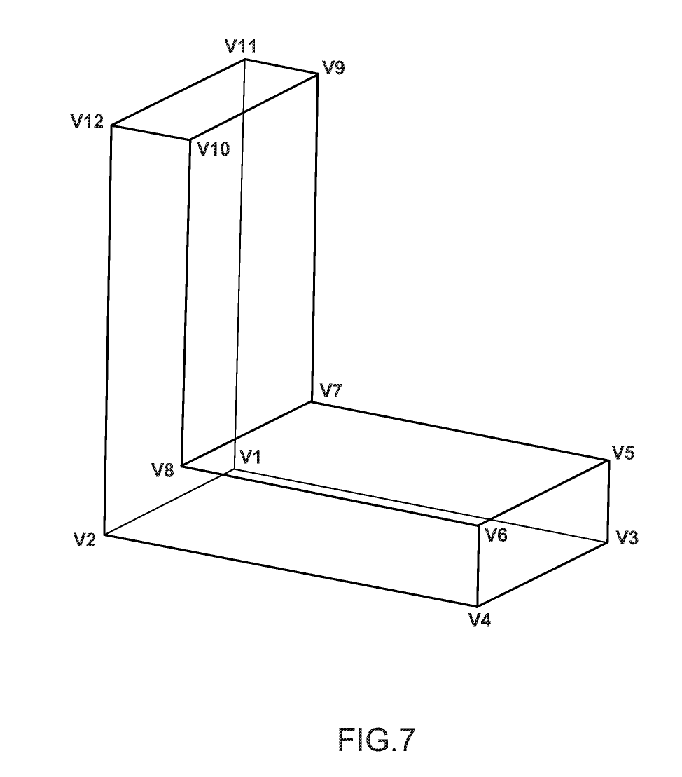

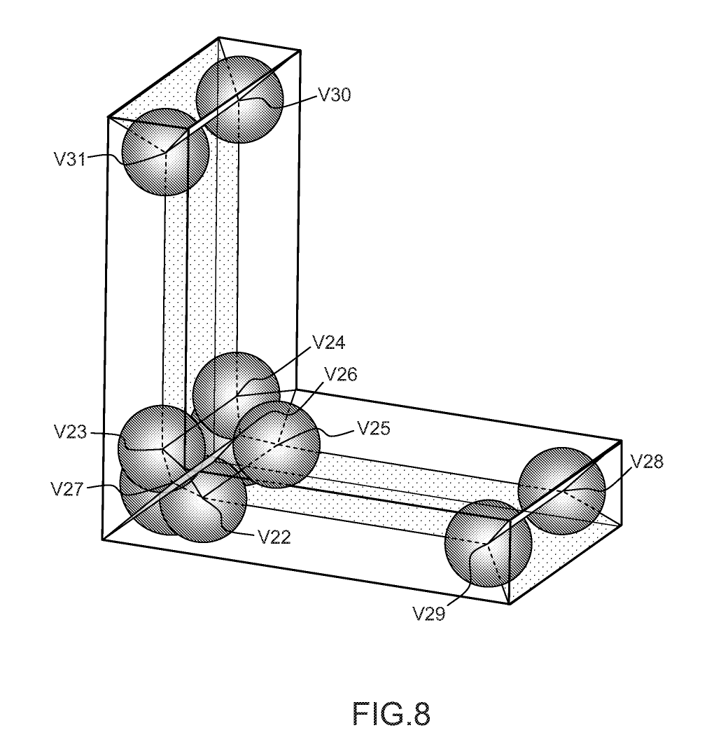

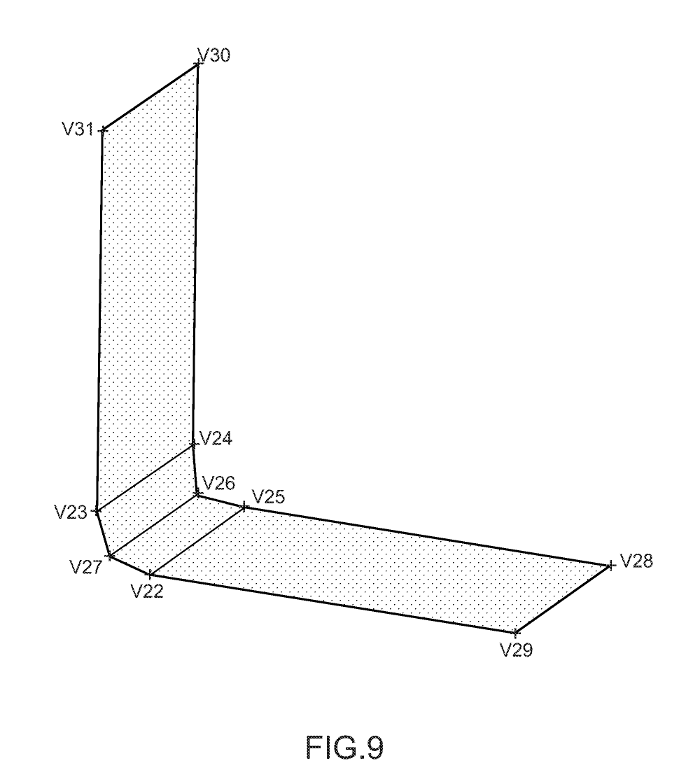

The above example is considered in 2D space for simplification. The data structure concept is extendable to 3D objects as illustrated in FIGS. 7 to 9: FIG. 7 shows a 3D object in the shape of an “L” as represented by its boundary elements; FIG. 8 shows the same 3D objects as defined completely by its MAT elements (the radius function is sketched discreetly at each of the MAT vertices by a sphere equal to the value of the radius); while FIG. 9 shows only the main elements of the medial axis transformation (i.e. non-zero radii elements) to illustrate the use of the MAT in higher level of abstraction of the object's shape and topology.

The two representations are equivalent and by various algorithms, as introduced before, the information may be converted. Furthermore, the two representations can be simultaneously kept in the data structure, which might or might not be linked: each MAT vertex is defined as the center of the circle—or sphere in 3D—tangent to at least 3 BREP elements or each BREP edge is fully defined by being tangent to the circles—or spheres in 3D—defined by at least two MAT vertices.

The representation method is extensible to objects defined by complex surfaces.

To assure a proof of integrity (fully defined solid object), a function has been developed to determine whatever a random point lies inside, outside or on the boundary of the object by using only the MAT data structure. An equivalent function exists for the BREP representation.

Based on the MAT representation, new creation and manipulation functions for solid objects can be derived. These functions may or may not make use of the information stored in the BREP data structure. Consequently, functions build for the BREP representation can be modified to make use of the MAT data structure improving their performance.

An object represented by a MAT method can be created from scratch or converted from a BREP object. The creation will make use of certain functions through which a CAD user can populate the data structure with the needed information; while the conversion (which can be manual or automatic) will make use of certain algorithms to calculate the needed information. Conceptually, by representing an object by the MAT method, the following steps are required:
1. define each MAT vertices as points in the space domain;
2. assign a radius function to the MAT vertices, i.e., for points a single value of the radius is needed;
3. define each MAT edge as a curve in space;
4. define the limits of the MAT edge as two MAT vertexes which lie on the curve;
5. assign a radius function to the MAT edge—the values at the limits of the edge are already defined at step 2. The function could be linear, i.e., the radius varies linearly along the MAT edge, in which case no additional parameters need to be specified, or non-linear, i.e., the radius does not vary linearly along the MAT edge, in which case additional parameters need to be specified depending on the nature of the radius variation. In a generic case the function can be defined numerically, piece-wise linear or using other numerical methods to define functions (e.g. polynomial, Bezier, B-spline etc.);
6. define a MAT face as a surface in space;
7. define the limits of the MAT face as a MAT (edge-)loop, composed of at least three MAT edges, sharing each a MAT node.
8. define the MAT links as the edges which are shared by at least two MAT faces, unlike in the BREP representation, a MAT edge can be shared by more than two faces;
9. assign a radius function to the MAT face. The values of this function at the limits of the edge are already defined at step 2 and 5. The function could be linear, in which case all the MAT vertices and MAT edges have to be linear and these functions need to be coplanar, or non-linear;
10. define a MAT object as a connected set of MAT faces, edges and vertices.

Depending on the creation or modification method, algorithm or purpose, the order of the steps might be different and might include additional steps specific to the function. Additional steps to check the integrity of the MAT object might be considered.

A hybrid MAT/BREP representation method will include conceptually the following additional steps—it is assumed the BREP elements are already constructed and valid:
1. for each MAT data structure element, i.e., vertex, edge, face, assign a link to the BREP data structure elements defining the respective MAT element. For example, as in FIG. 4, the MAT vertex 2 (mv2) will be defined by the BREP edges 0, 1 and 5 (be0, be1 and be5);
2. for each BREP data structure element (i.e. vertex, edge, face) assign a link to the MAT data structure elements defining the respective BREP element. For example, as in FIG. 4, BREP edge 2 (be2) will be defined by the MAT edges 6 and 7 (me6 and me7) and the MAT vertices 6, 7 and 8 (mv6, mv7 and mv8).

Among the advantages of employing the MAT representation in a CAD system we enumerate:
advanced early stage design functions. A 3D or 2D object can be more rapidly and intuitively defined employing the MAT representation;
the use of the MAT representation to attach physical meaning to the virtual object, by making use of the properties of the MAT representation, such as point mapping;
automatic preparation of Finite Element model for analysis. The topological information contained in the MAT representation can be used to generate automatically relevant FEM meshes employing either same dimension elements or reduced-order elements for rapid simulation times;
recovery of FEA results for integration inside CAD environment. The medial axis corresponds to the neutral axis in structural mechanics, with particular properties which makes this representation more appropriate in recovering and mapping a deformed mesh on the initial object;
advanced functions for analysis or modification of a geometrical model. Determining the minimum thickness of a part using the BREP representation is a daunting task, while this information is readily available, by reading the radius function along the MAT graph, in a MAT representation. Furthermore, the thickness of an object can be easily changed to respond to a user need;
geometry simplification functions. The topological information contained in the MAT structure can be used to identify which geometrical features are irrelevant to the overall part shape and potentially to its physical behavior. Such a function is sought after when preparing a complex CAD model for numerical simulation.

Many other functions and applications are possible.

### 4D Solid Modeling Representation

The current solid modeling representations are suitable for representing and manipulating 3D objects. However, in many products designed using CAD systems, various parts are either in motion, or shape changing, and these changes are typically the ones defining the function of the product. Employing assembly functions, the position and orientation of objects can be changed relative to others. However, the results of these functions cannot be stored in the current BREP data structures, in order to edit and further manipulate this information in a structured manner.

The proposed MAT data structure as in FIG. 5 is capable to represent objects that are changing their position and orientation or their shape in time, by simply adding a 4th parameter corresponding to time in the definition of the geometrical elements—point, curve and surface—and a new type of element, the MAT shell (not represented in the figure).

The BREP representation model can also be extended to 4D, but only by adding a few more elements and concepts, therefore allowing a hybrid representation method to function in 4-dimensions. Existing and/or new functions for creating and manipulating 4D objects will be used to allow the user to create and modify functional products.

The following advantages are noted when employing a 4D data structure inside a CAD system:
functional design functions. A new set of functions will be created to allow the functional design of a product. The imposed movement of a “lead” object (or several) can be defined and modified in a similar way a 3D object is created. Constrains can be created between position in time and geometry allowing a functional parametric design of assemblies.
the 4D geometry can be used to drive position and orientation of the complete assembly by imposing a movement on one or several objects. Unwanted contacts in use can be identified and corrected as needed. The MAT representation is found particularly suitable for identifying contact in both static and transient conditions. A functional simulation of a product can be achieved efficiently and in the same time stored together with the static product information.

### BIBLIOGRAPHY

Blum, H. (1973). Biological Shape and Visual Science (Part I). Journal of theoretical biology, 38, 205-287.
Braid, I., Hillyard, R., & Stroud, I. (1980). Stepwise construction of a polyhedra in geometric modelling (1978). (K. W. Brodlie, Ed.) Mathematical Methods in Computer Graphics and Design.
DeSimone, F., Sevici, C., & Mental, K. (2013). U.S. Pat. No. 8,330,775 B2.
Desimone, F., Sevici, C., & Mental, K. (2012). U.S. Pat. No. 8,207,990 B1.
Stroud, I. (2006). Boundary Representation Modelling Techniques. London: Springer-Verlag London Limited.
Stroud, I., Renner, G., & Xirouchakis, P. (2007). A divide and conquer algorithm for medial surface calculation of planar polyhedra. Computer-Aided Design, 39, 794-817.

1. A method for achieving a representation of an object within a data structure for a Computer Aided Design (CAD) system employing a Medial Axis Transformation (MAT), the representation of the object comprising a set of adjacent bounded surface elements called medial axis transformation faces, the medial axis transformation faces being bound by sets of medial axis transformation edges, which are portions of curves lying on a surface of the medial axis transformation faces on either side of the edge, and points where several medial axis transformation faces meet are called medial axis transformation vertices, the method comprising at least
defining each of the medial axis transformation vertices as points in a space domain;
assigning a radius function to each of the medial axis transformation vertices, based on only a single value;
defining each of the medial axis transformation edges as a curve in space;
defining limits of each of the medial axis transformation edges as two medial axis transformation vertexes which lie on the curve;
assigning a radius function to each of the medial axis transformation edges;
defining each of medial axis transformation faces as a surface in space;
defining the limits of each of the medial axis transformation faces as a medial axis transformation loop, comprising at least three medial axis transformation edges, sharing each a medial axis transformation node, whereby a direction, clockwise or counter-clockwise, of the medial axis transformation loop defines on which side of the medial axis transformation loop the medial axis transformation face will be formed;
defining the medial axis transformation links as the edges which are shared by at least two medial axis transformation faces;
assigning a radius function to each of the medial axis transformation faces; and
defining a medial axis transformation object as a connected set of medial axis transformation faces, edges and vertices.

2. The method of claim 1, where in the step of assigning the radius function to each of the medial axis transformation edges, the function is linear, whereby the radius varies linearly along the medial axis transformation edge.

3. The method of claim 1, where in the step of assigning the radius function to each of the medial axis transformation edges, the function is non-linear, whereby the radius does not vary linearly along the medial axis transformation edge.

4. The method of claim 1, where in the step of assigning the radius function to each of the medial axis transformation edges, the function is defined numerically, piece-wise linear or by other methods to define numerical functions.

5. The method of claim 1, where in the step of assigning the radius function to each of the medial axis transformation faces, the function is linear, whereby the medial axis transformation vertices and medial axis transformation edges are linear and coplanar.

6. The method of claim 1, where in the step of assigning the radius function to each of the medial axis transformation faces, the function is non-linear.

7. The method of claim 1, where in the step of assigning the radius function to each of the medial axis transformation edges, the function is defined numerically, piece-wise linear or other methods for defining numerical functions.

8. The method of claim 1, wherein the representation of the object is achieved together with a Boundary Representation (BREP), further comprising
for each medial axis transformation data structure element, assigning a link to boundary representation data structure elements defining the respective medial axis transformation element; and
for each boundary representation data structure element assign a link to the medial axis transformation data structure elements defining the respective boundary representation element.

9. A Computer Aided Design CAD system configured to implement geometric engine functions that use a medial axis transformation based data structure as a solid representation method.

10. The system of claim 9, wherein the geometric engine functions use the medial axis transformation based data structure solid representation method together with a boundary representation method.

11. A Computer Aided Design CAD system configured to implement part and assembly modeling functions that use a medial axis transformation based data structure as a solid representation method.

12. The system of claim 11, wherein the part and assembly modeling functions use the medial axis transformation based data structure solid representation method together with a boundary representation method.

13. A user interface configured to enable a creation and manipulation of objects represented by a medial axis transformation-based data structure at least as a solid representation method.

14. The method for achieving a representation of an object within a data structure for a Computer Aided Design (CAD) system of claim 1, wherein the representation of the object further comprises a 4th parameter corresponding to time and a medial axis transformation shell, thereby enabling a 4-dimensional solid representation method.

15. A Computer Aided Design CAD system configured to implement geometric engine functions that use a 4-dimensional solid representation method.

16. A Computer Aided Design CAD system configured to implement part and assembly modeling functions that use a 4-dimensional solid representation method.

17. A user interface configured to enable a creation and manipulation of objects represented in a 4-dimensional environment by a 4-dimensional solid representation method.
